(19) United States
(12) Patent Application Publication
(10) Pub. No.: US 2005/0002316 A1
(43) Pub. Date: Jan. 6, 2005

(54) Laser driver circuit with reduced noise and optical pickup circuit for use with the same

(76) Inventor: Sho Maruyama, Kyoto (JP)

Correspondence Address: CANTOR COLBURN LLP, 55 Griffin Road South, Bloomfield, CT, 06002, US

(21) Appl. No.: 10/882,748

(22) Filed: Jul. 1, 2004

(30) Foreign Application Priority Data
Jul. 1, 2003 (JP) JP2003-189857

(51) Int. Cl. G11B 7/00; G11B 7/085

(52) U.S. Cl. 369/116; 369/47.5

(57) ABSTRACT

An optical pickup with a laser driver circuit is provided to overcome an increase in size of an optical pickup, which is caused by a ferrite bead or capacitor being provided in a drive current path to reduce EMI noise effects. In an optical disc apparatus, an optical sensor element detects a laser beam from a laser emission element included in an optical pickup circuit and then sends the detected signal to a main circuit board. An APC circuit in the main circuit board outputs a control signal to control the laser output from the laser emission element at a constant level in accordance with the detected signal from the optical sensor element. A laser driver circuit included in the optical pickup circuit incorporates a transistor and a high-frequency wave superposition circuit). The transistor produces a drive current in accordance with the control signal from the APC circuit, while the high-frequency wave superposition circuit superposes a high-frequency current on the drive current. The drive current superposed with the high-frequency current drives the laser emission element.

### BACKGROUND OF THE INVENTION

1. Field of the Invention

The present invention relates to amplifier circuits, and more particularly, to a technique for improving the frequency characteristics of a differential amplifier circuit.

2. Description of the Related Art

Conventionally, a method for reducing optical return noise generated in an optical pickup, such as a CD or DVD drive apparatus, is known in which a high-frequency wave superposition module is used (e.g., see Japanese Patent Laid-Open Publication No. Hei 5-48184). In general, the optical pickup employs a laser emission element to read information on optical discs such as CDs or DVDs. The optical return noise caused by a reflected beam from the optical disc may have adverse effects on an optical pickup playback signal. To overcome this problem, the high-frequency wave superposition module is designed to superpose a high-frequency current on the drive current for the laser emission element to stabilize the laser output.

On the other hand, superposing a high-frequency current on the drive current for the laser emission element by the high-frequency wave superposition module would readily cause EMI (Electromagnetic Interference) noise. It was thus conventionally necessary to provide a ferrite bead or capacitor in a drive current path in order to reduce the EMI noise effects on a main circuit board. However, the provision of the ferrite bead or capacitor would cause an increase in size of the optical pickup.

### SUMMARY OF THE INVENTION

The inventor developed the present invention in view of the aforementioned problems. It is therefore an object of the present invention to provide a laser driver circuit with both reduced EMI noise and size.

An aspect of the present invention provides a laser driver circuit. The laser driver circuit incorporates into the same package a drive element which drives a laser emission element and a high-frequency wave superposition circuit which superposes a high-frequency current on a drive current produced by the drive element.

According to this aspect, the high-frequency wave superposition circuit included in an optical pickup circuit is incorporated into one chip, in which the drive element for driving the laser emission element is also integrated to serve as the laser driver circuit. In this case, since the drive current line does not extend to the main circuit board, EMI noise would not reach the main circuit board, thereby eliminating the need for providing a ferrite bead or capacitor in the drive current line. It is therefore made possible to reduce EMI noise and the size of the circuit.

Another aspect of the present invention also provides a laser driver circuit. The laser driver circuit comprises: an input terminal which receives a control signal from an external automatic power control circuit which controls laser output from a laser emission element at a constant level based on a detected result thereof obtained by an optical sensor element; a drive element which drives the external laser emission element based on the control signal; an output terminal which delivers a drive current produced by the drive element to the laser emission element; and a high-frequency wave superposition circuit which superposes a high-frequency current on the drive current delivered to the laser emission element.

According to this aspect, the automatic power control circuit (hereinafter referred to as the APC circuit) provided on the main circuit board or the like controls the operation of the drive element. However, since the drive element is provided within the laser driver circuit, EMI noise generated by the superposition of the high-frequency current will not reach the main circuit board that includes the automatic power control circuit. Accordingly, without the need for interposing a ferrite bead or capacitor between the automatic power control circuit and the drive element, it is possible to reduce both EMI noise and the size of the circuit.

A further aspect of the present invention also provides a laser driver circuit. The laser driver circuit comprises: a plurality of input terminals which receive respective control signals for a plurality of laser emission elements of different frequencies from an external automatic power control circuit which controls the laser output from the laser emission elements at a constant power level based on a detected result thereof obtained by an optical sensor element; a plurality of drive elements which drive the plurality of laser emission elements based on the control signals, respectively; a plurality of output terminals which deliver respective drive currents produced by the plurality of drive elements to the plurality of laser emission elements, respectively; and a high-frequency wave superposition circuit for superposing a high-frequency current on each of the drive currents to be delivered to the plurality of laser emission elements.

According to this aspect, laser emission elements for a CD and DVD can be separately driven and controlled, in each case of which EMI noise generated by the superposition of the high-frequency current will not reach the main circuit board. Therefore, even in the laser driver circuit for use both with CDs and DVDs, it is possible to reduce both EMI noise and the size of the circuit.

A still another aspect of the present invention provides an optical pickup circuit. The optical pickup circuit comprises a laser driver circuit, and a laser emission element which is connected external to the laser driver circuit and driven with a drive current superposed with a high-frequency current.

Like the aforementioned other aspects, this aspect also allows for preventing EMI noise, which is generated by the superposition of the high-frequency current on the drive current for the laser emission element, from reaching the main circuit board. It is therefore possible to realize an optical pickup circuit which can reduce EMI noise and the size of the circuit.

Incidentally, any combinations of the foregoing components, and the expressions of the present invention converted among methods, apparatuses, circuits, and the like are also intended to constitute applicable aspects of the present invention.

### BRIEF DESCRIPTION OF THE DRAWINGS

FIG. 1 is a view showing a high-frequency wave oscillator circuit according to a third embodiment;

FIG. 2 is a view showing the configuration of a variable current supply;

FIG. 3 is a view showing the configuration of a high-frequency wave oscillator circuit for comparison with the characteristics of the high-frequency wave oscillator circuit of FIG. 1;

FIGS. 4(a) and 4(b) are views each showing an output waveform experimentally obtained from the high-frequency wave oscillator circuits of FIGS. 1 and 3;

FIG. 5 is a view showing the configuration of a high-frequency wave oscillator circuit according to a fourth embodiment;

FIGS. 6(a), 6(b) and 6(c) are views showing the configuration of an optical pickup or an exemplary application of a high-frequency wave oscillator circuit according to a fifth embodiment;

FIG. 7 is a view showing the configuration of an optical disc apparatus according to a first embodiment of the present invention; and

FIG. 8 is a view showing the configuration of an optical disc apparatus according to a second embodiment of the present invention.

### DETAILED DESCRIPTION OF THE INVENTION

### FIRST EMBODIMENT

A first embodiment of the present invention provides an optical disc apparatus which includes a pair of a laser emission element and an optical sensor element. The pair of the laser emission element and the optical sensor element is provided within an optical pickup circuit, while a drive element for driving the laser emission element is incorporated into a laser driver circuit to be accommodated within the optical pickup circuit.

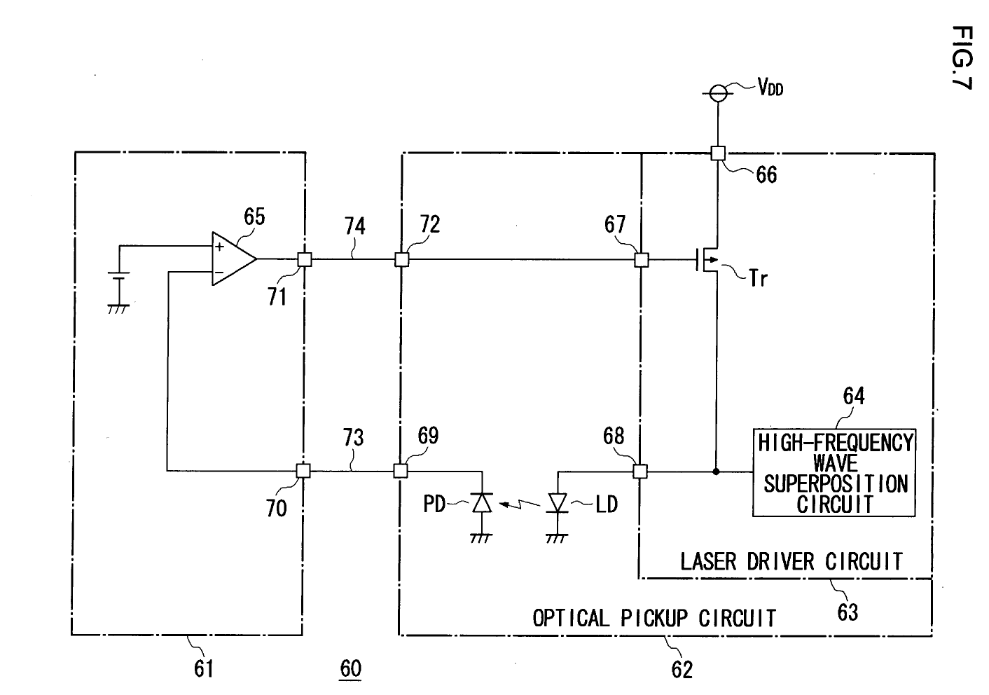

FIG. 7 illustrates the configuration of an optical disc apparatus according to the first embodiment of the present invention. The optical disc apparatus 60 includes a main circuit board 61 and an optical pickup circuit 62. The main circuit board 61 mainly includes an APC circuit 65. The optical pickup circuit 62 mainly includes a laser emission element LD, an optical sensor element PD, and a laser driver circuit 63. The laser emission element LD is a semiconductor laser diode which emits light when a current is applied thereto. The laser emission element LD is connected to an output terminal 68 of the laser driver circuit 63 and driven by the laser driver circuit 63 to emit a laser beam. The optical sensor element PD is a photo-diode which converts a received light beam into an electrical signal. Upon sensing a portion of a laser beam emitted from the laser emission element LD, the optical sensor element PD delivers a light detection signal from a first terminal 69. The light detection signal delivered from the first terminal 69 is supplied to a second terminal 70 of the main circuit board 61 via a first connector 73. Based on the detected result of a laser beam provided by the optical sensor element PD, the APC circuit 65 feedback controls the laser output from the laser emission element LD at a constant power level. The APC circuit 65 amplifies the voltage difference between the light detection signal received from the second terminal 70 and a reference voltage to produce a control signal, which is delivered from a third terminal 71. The control signal delivered from the third terminal 71 is supplied to a fourth terminal 72 of the optical pickup circuit 62 via a second connector 74.

The control signal supplied from the fourth terminal 72 of the optical pickup circuit 62 is provided to the laser driver circuit 63 via an input terminal 67. The laser driver circuit 63 has a transistor Tr and a high-frequency wave superposition circuit 64 incorporated in the same package, in which the transistor Tr serves as a drive element for driving the laser emission element LD and the circuit 64 superposes a high-frequency current on a drive current produced by the transistor Tr. For example, the transistor Tr is a p-channel MOS transistor with the gate connected to the input terminal 67, the source to a power supply terminal 66, and the drain to the output terminal 68. The power supply terminal 66 is connected to a voltage power supply V_{DD}. The voltage of the control signal supplied from the input terminal 67 is applied to the gate of the transistor Tr, which produces a drive current between the source and the drain in accordance with the voltage applied. The drive current produced by the transistor Tr is superposed with a high-frequency current by the high-frequency wave superposition circuit 64 and then delivered to the laser emission element LD via the output terminal 68. This realizes feedback control provided by the APC circuit 65 to the laser emission element LD.

Suppose that the transistor Tr for driving the laser emission element LD was not incorporated in the laser driver circuit 63 but on the main circuit board 61. In this case, a drive current line was to be formed from the main circuit board 61 through the connector to the laser emission element LD in the optical pickup circuit 62. In this case, with the high-frequency wave superposition circuit 64 superposing a high-frequency current on the drive current, EMI noise to be generated would have effects on the main circuit board 61 through the drive current line. It would be therefore necessary to provide a ferrite bead or capacitor in the drive current line, thereby reducing EMI noise.

However, in this embodiment, the transistor Tr is included within the laser driver circuit 63, thereby making it possible to block the EMI noise effects to be otherwise exerted on the main circuit board 61. It is thus possible to reduce the optical pickup circuit 62 in size without the need for providing a ferrite bead or capacitor in the drive current line.

### SECOND EMBODIMENT

An optical disc apparatus according to this embodiment is different from the first embodiment of the present invention in having a plurality of laser emission elements, optical sensor elements, APC circuits, and transistors serving as drive elements. In particular, this embodiment has circuits or elements in twos such as laser emission elements, each for use with CDs and DVDs. Now, this embodiment will be explained below with a particular emphasis on the difference from the first embodiment of the present invention.

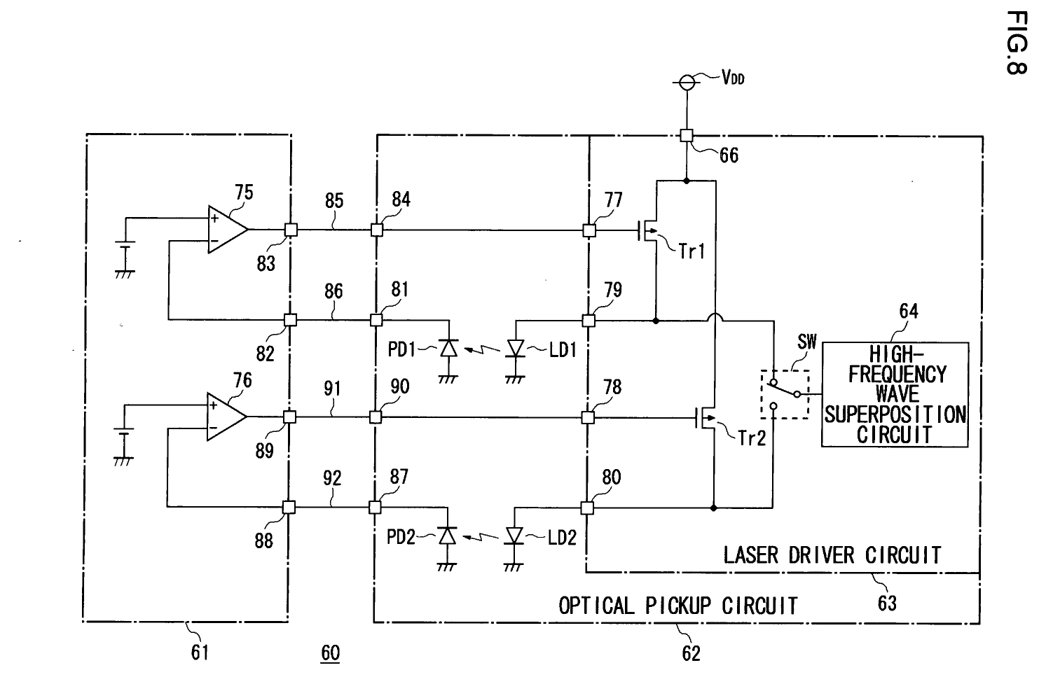

FIG. 8 shows the configuration of an optical disc apparatus according to the second embodiment of the present invention. A main circuit board 61 mainly includes a first APC circuit 75 and a second APC circuit 76. An optical pickup circuit 62 mainly includes a first laser emission element LD1, a second laser emission element LD2, a first optical sensor element PD1, a second optical sensor element PD2, and a laser driver circuit 63. The first and second laser emission elements LD1, LD2 are semiconductor diodes having frequencies different from each other. The first laser emission element LD1 is connected to a first output terminal 79 of the laser driver circuit 63. The first optical sensor element PD1 detects a portion of a laser beam emitted from the first laser emission element LD1 to deliver a light detection signal from a first terminal 81. The light detection signal delivered from the first terminal 81 is supplied to a second terminal 82 of the main circuit board 61 via a second connector 86. The first APC circuit 75 amplifies the voltage difference between the light detection signal supplied from the second terminal 82 and a reference voltage to produce a control signal, which is delivered from a third terminal 83. The control signal delivered from the third terminal 83 is supplied to a fourth terminal 84 of the optical pickup circuit 62 via a first connector 85.

The control signal supplied from the fourth terminal 84 of the optical pickup circuit 62 is provided to the laser driver circuit 63 via a first input terminal 77. The laser driver circuit 63 includes, in the same package, a first transistor Tr1 for driving the first laser emission element LD1, a second transistor Tr2 for driving the second laser emission element LD2, and a high-frequency wave superposition circuit 64. The first transistor Tr1 has the gate connected to the first input terminal 77, the source to the power supply terminal 66, and the drain to the first output terminal 79. The voltage of the control signal supplied from the first input terminal 77 is applied to the gate of the first transistor Tr1, which produces a drive current between the source and the drain in accordance with the voltage applied. The drive current produced by the first transistor Tr1 is superposed with a high-frequency current by the high-frequency wave superposition circuit 64 and then delivered to the first laser emission element LD1 via the first output terminal 79. This realizes feedback control provided by the first APC circuit 75 to the first laser emission element LD1.

The second laser emission element LD2 is connected to a second output terminal 80 of the laser driver circuit 63. The second optical sensor element PD2 detects a portion of a laser beam emitted from the second laser emission element LD2 to deliver a light detection signal from a fifth terminal 87. The light detection signal delivered from the fifth terminal 87 is supplied to a sixth terminal 88 of the main circuit board 61 via a fourth connector 92. The second APC circuit 76 amplifies the voltage difference between the light detection signal supplied from the sixth terminal 88 and a reference voltage to produce a control signal, which is delivered from a seventh terminal 89. The control signal delivered from the seventh terminal 89 is supplied to an eighth terminal 90 of the optical pickup circuit 62 via a third connector 91.

The control signal supplied from the eighth terminal 90 of the optical pickup circuit 62 is provided to the laser driver circuit 63 via a second input terminal 78. The second transistor Tr2 has the gate connected to the second input terminal 78, the source to the power supply terminal 66, and the drain to the second output terminal 80. The voltage of the control signal supplied from the second input terminal 78 is applied to the gate of the second transistor Tr2, which produces a drive current between the source and the drain in accordance with the voltage applied. The drive current produced by the second transistor Tr2 is superposed with a high-frequency current by the high-frequency wave superposition circuit 64 and then delivered to the second laser emission element LD2 from the second output terminal 80. The high-frequency wave superposition circuit 64 allows a switch SW to select either one of the drive currents produced by the first or the second transistor Tr1, Tr2 and then superposes a high-frequency current on the resulting drive current.

Like the first embodiment of the present invention, this embodiment also allows the first and second transistor Tr1, Tr2 to be incorporated into the laser driver circuit 63. This configuration allows for blocking EMI noise effects to be otherwise exerted on the main circuit board 61, eliminating the need for providing a ferrite bead or capacitor, and reducing the optical pickup circuit 62 in size.

### THIRD TO FIFTH EMBODIMENTS

The high-frequency wave superposition circuit 64 and the optical pickup circuit 62 according to the first and second embodiments of the present invention may also be practiced as in the third through fifth embodiments discussed below.

### PRECONDITIONS FOR THIRD TO FIFTH EMBODIMENTS

For example, the conventional voltage controlled oscillator circuit is used for an optical pickup or PLL (Phase Locked Loop), and generally varies an oscillation frequency setting in accordance with an applied control voltage to provide an oscillatory output signal at the oscillation frequency. An example of the conventional voltage controlled oscillator has an inverting amplifier, a first charge/discharge circuit, and a second charge/discharge circuit, which are connected in that order with the last connected back to the first. In this configuration, the phase of an inverted voltage signal from the inverting amplifier is delayed in a stepwise manner in the first and second charge/discharge circuits, allowing the output from the second charge/discharge circuit to be supplied back to the inverting amplifier. Since the phase of the inverted voltage signal having gone through the first and second charge/discharge circuits is the same as the initial phase, the voltage controlled oscillator can continue to oscillate by repeating the aforementioned processing. The oscillation frequency provided by the voltage controlled oscillator is determined mainly depending on the magnitude of the charge/discharge currents in the first and second charge/discharge circuits. The magnitude of the charge/discharge current is controlled using a control current which is greater in level and easier to control than the charge/discharge current.

In the prior art, the control is provided using a control current. Thus, even with a very small charge/discharge current, the stabilized level of current for control allows continual stable oscillations even at low oscillation frequencies. On the other hand, in general, to provide oscillations at higher frequencies, the following problems need to be further addressed. Suppose that an oscillatory signal is provided at a high oscillation frequency and then converted into a current signal by means of a FET (Field Effect Transistor, which is hereinafter referred to as the “converting FET”). In this case, the conversion may readily cause a distortion to occur in the oscillatory signal. Furthermore, in the presence of higher order harmonics, the distortion tends to worsen EMI (Electromagnetic Interference) characteristics. On the other hand, a larger amount of power consumption is generally required to deliver an oscillatory signal eventually from the oscillator circuit at a higher oscillation frequency with a greater amplitude. A lower power consumption is preferable to incorporate the oscillator circuit into a battery-driven apparatus; however, to reduce power consumption, the efficiency of converting a voltage signal to a current signal has to be improved.

On the other hand, LSI (Large Scale Integrated Circuit) vendors who provide an oscillator circuit incorporated into an LSI may desire generally-usable LSIs to achieve the economies of mass production. On the other hand, set makers who incorporate LSIs into an apparatus or the like may desire an oscillator circuit which allows the amplitude of its output signal to be variably defined depending on the requirements of the apparatus and which operates at low power consumption. Accordingly, appropriate characteristics are required of the oscillator circuit in terms of the amplitude of an output signal and power consumption. Furthermore, for the set makers to incorporate the oscillator circuit into a predetermined apparatus and provide a larger setting to the amplitude of the output signal, the waveform distortion or the EMI characteristics need also to meet a predetermined requirement.

The object of the third to fifth embodiments of the present invention is to provide an oscillator circuit which is capable of delivering an oscillatory signal variably in amplitude and which provides improved waveform distortion characteristics.

An aspect of the means for solving the problems in the third to fifth embodiments is an oscillator circuit. This oscillator circuit includes an oscillatory signal generator circuit for delivering an oscillatory signal as a differential signal, a differential amplifier for amplifying the differential signal delivered from the oscillatory signal generator circuit, a converter circuit for converting the differential signal amplified by the differential amplifier from a voltage signal to a current signal, and a driver circuit for delivering a drive current variably at a magnitude corresponding to an externally supplied setting signal to activate the converter circuit.

The amplification factor of the differential amplifier may be appropriately set corresponding to the circuit involved, in the case of which the amplification factor may be greater than one, equal to one, or less than one.

The converter circuit may be designed so as to increase a converted current signal in amplitude when the drive current has been increased by the setting signal supplied to the driver circuit.

The oscillator circuit configured as described above processes differential signals to cancel the distortion components contained in the signals, thereby reducing the distortion components in the signal waveform. The drive current for eventually converting a voltage signal to a current signal is varied in magnitude to adjust the amplitude of the converted current signal, thereby making it possible to improve the conversion efficiency and reduce power consumption.

Another aspect of the means for solving the problems in the third to fifth embodiments is also an oscillator circuit. This oscillator circuit includes an oscillatory signal generator circuit for delivering an oscillatory signal as a differential signal, a differential amplifier for amplifying the differential signal delivered from the oscillatory signal generator circuit, a converter circuit for converting the differential signal amplified by the differential amplifier from a voltage signal to a current signal, and a driver circuit for delivering a drive current variably at a magnitude corresponding to an externally supplied setting signal to activate the differential amplifier.

The differential amplifier may be designed to operate at higher speeds when the drive current is increased using the setting signal supplied to the driver circuit.

In response to the requirement for the amplitude of the converted current signal, the aforementioned oscillator circuit adjusts the magnitude of the drive current flowing through the differential amplifier to reduce an unnecessary current, thereby providing an increased conversion efficiency. Additionally, when the amplitude required of the current signal is small, the drive current is adjusted to reduce the amplitude of the differential signal delivered from the differential amplifier. This allows for reducing the noise which occurs between the power supply for the differential amplifier and the ground and which is added to the differential signal, thereby making it possible to output a current signal with reduced noise effects.

### THIRD EMBODIMENT

The third embodiment relates to a high-frequency wave oscillator circuit provided on the preconditions that LSI vendors manufacture the circuit so as to provide an oscillatory signal variably in magnitude for general purposes and that set makers incorporate the circuit with a predetermined amplitude setting into a predetermined apparatus. The high-frequency wave oscillator circuit according to this embodiment provides an oscillatory signal at an oscillation frequency corresponding to a control voltage applied. Furthermore, the voltage of the oscillatory signal is amplified in amplitude to such an extent as to be capable of switching a converting FET in the subsequent stage (the FET used for amplification is hereinafter referred to as the amplifying FET). The amplified oscillatory signal is further converted from a voltage signal to a current signal with the converting FET. In particular, this embodiment is adapted such that the oscillatory signal is oscillated and amplified in accordance with differential signals, thereby allowing for canceling signal distortions to thereby reduce the distortion components in the signal waveform. Furthermore, to adjust the amplitude of the oscillatory signal converted into a current signal, the magnitude of the drive current flowing through the converting FET is directly adjusted, thereby improving the conversion efficiency and reducing power consumption.

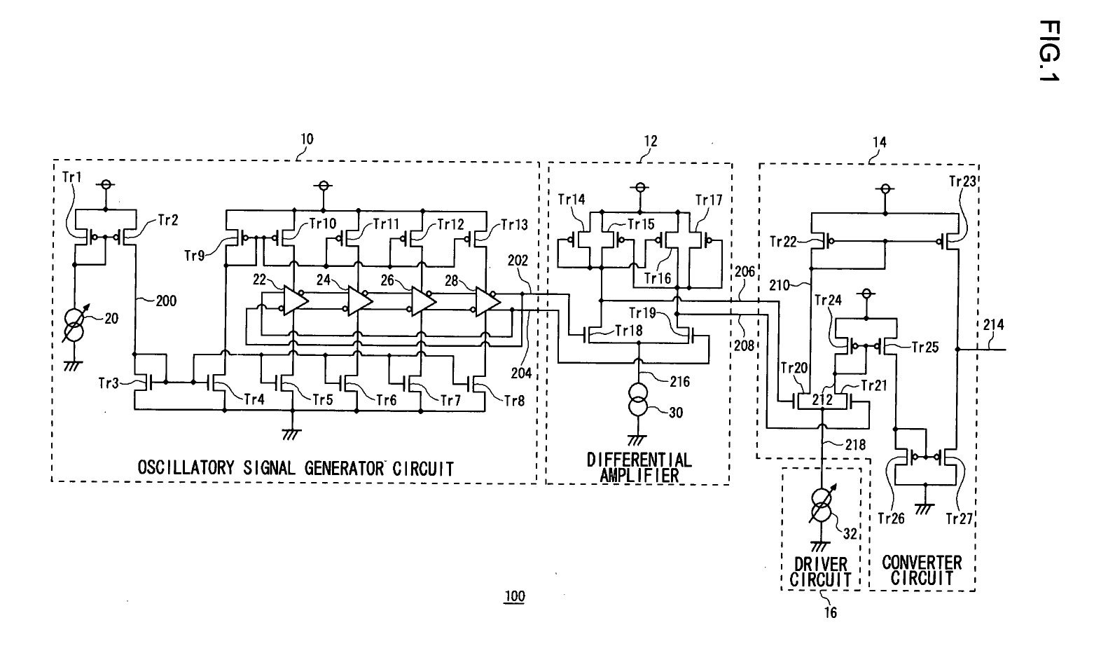

FIG. 1 illustrates a high-frequency wave oscillator circuit 100 according to the third embodiment. The high-frequency wave oscillator circuit 100 includes an oscillatory signal generator circuit 10, a differential amplifier 12, a converter circuit 14, and a driver circuit 16. The oscillatory signal generator circuit 10 includes a variable current supply 20, a first inverter 22, a second inverter 24, a third inverter 26, a fourth inverter 28, and transistors Tr1 to Tr13. The differential amplifier 12 includes a constant current supply 30 and transistors Tr14 to Tr19. The converter circuit 14 includes transistors Tr20 to Tr27, while the driver circuit 16 includes a variable current supply 32. Provided as signals are an oscillator drive current 200, a first generated oscillatory signal 202, a second generated oscillatory signal 204, a first amplified oscillatory signal 206, a second amplified oscillatory signal 208, a first current oscillatory signal 210, a second current oscillatory signal 212, an output current oscillatory signal 214, an amplifier drive current 216, and a converting drive current 218.

As oscillatory signals, the oscillatory signal generator circuit 10 produces the first and second generated oscillatory signals 202, 204 serving as differential signals. The variable current supply 20 provides a current having a magnitude that is varied in accordance with a control voltage applied. Since the transistors Tr1 and Tr2 constitute a current mirror circuit, the oscillator drive current 200 flows in proportion to the magnitude of the current delivered from the variable current supply 20.

The transistors Tr3 to Tr8 constitute a current mirror circuit, while the transistors Tr9 to Tr13 also constitute a current mirror circuit. These current mirror circuits supply a current proportional to the oscillator drive current 200 to differential output ring oscillators each made up of the first inverter 22, the second inverter 24, the third inverter 26, and the fourth inverter 28. That is, since a larger current flows into the differential output ring oscillator as the oscillator drive current 200 increases, the first and second generated oscillatory signals 202, 204 will be delivered from the differential output ring oscillator at a higher oscillation frequency. For example, like a sinusoidal wave, the first and second generated oscillatory signals 202, 204, which have the maximum and minimum values appearing alternately at predetermined intervals, provide differential signals relative to each other. The differential signal is also called a “balance signal,” whereas an ordinary signal with respect to a constant voltage such as ground may be called as an “unbalance signal.”

The differential amplifier 12 differentially amplifies the first and second generated oscillatory signals 202, 204 to output the first and second amplified oscillatory signals 206, 208, respectively. The differential amplification is carried out to improve the transistor Tr20 or Tr21 in driving capability, discussed later. The transistors Tr14 to Tr19 constituting the differential amplifier 12 are driven with the amplifier drive current 216 from the constant current supply 30. The first and second generated oscillatory signals 202, 204 are applied to the gate terminal of the transistors Tr18, Tr19, respectively, to be differentially amplified. Thus, the first and second amplified oscillatory signals 206, 208 or differential signals are delivered which have the same waveform as that of the first and the second generated oscillatory signal 202, 204. The transistors Tr14 to Tr19 correspond to the aforementioned amplifying FET.

The variable current supply 32 provides the converting drive current 218 for driving the transistors Tr20, Tr21, discussed later, to convert the first and second amplified oscillatory signals 206, 208 from voltage into current signals. Although detailed later, it is possible to externally adjust the value of a variable resistor included in the variable current supply 32 to thereby control the magnitude of the converting drive current 218.

The converter circuit 14 converts the first and the second amplified oscillatory signal 206, 208 into the output current oscillatory signal 214 which has a sink current and a source current switched alternately. Hereinafter, it is to be understood that the output current oscillatory signal 214 include a sink current and a source current. The transistor Tr20 converts the first amplified oscillatory signal 206 applied to the gate terminal into the first current oscillatory signal 210. Since the transistor Tr20 is an n-channel transistor, the value of the first current oscillatory signal 210 approaches that of the converting drive current 218 as the value of the first amplified oscillatory signal 206 increases. The transistor Tr21, which operates in the same manner as the transistor Tr20, converts the second amplified oscillatory signal 208 into the second current oscillatory signal 212.

The transistors Tr22, Tr23 constitute a current mirror circuit, and converts the first current oscillatory signal 210 into a first output current signal proportional thereto. On the other hand, the transistors Tr24, Tr25 and the transistors Tr26, Tr27 constitute a current mirror circuit, respectively, and convert the second current oscillatory signal 212 into a second output current signal proportional thereto. Furthermore, the first and second output current signals are turned to the output current oscillatory signal 214 with the aforementioned sink and source currents being switched by a switching operation of the transistors Tr20, Tr21.

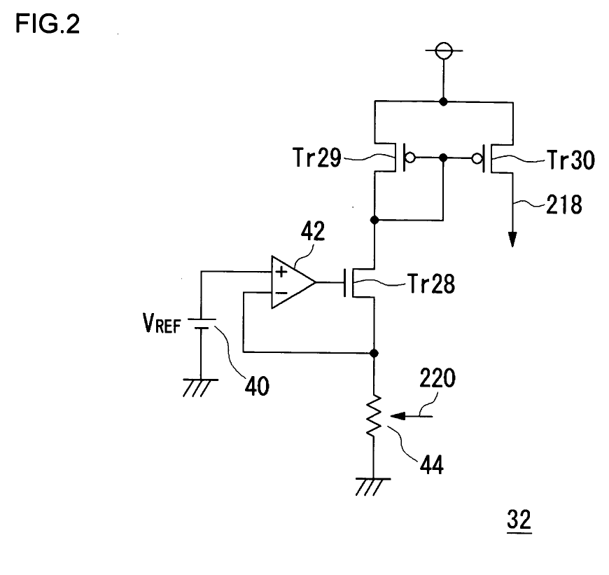

FIG. 2 illustrates the configuration of the variable current supply 32. The variable current supply 32 includes a reference voltage supply 40, an operational amplifier 42, a variable resistor 44, and transistors Tr28 to Tr30. Provided as a signal is a setting signal 220.

The variable resistor 44 converts a predetermined constant voltage into a current and has a value which is adjusted corresponding to the setting signal 220 externally applied.

The reference voltage supply 40, the operational amplifier 42, and the transistor Tr28 stabilize the value of the current converted by the variable resistor 44. Since the operational amplifier 42 amplifies the gate voltage of the transistor Tr28, the transistor Tr28 is used in the saturation region of the drain current characteristic.

The transistors Tr29, Tr30 constitute a current mirror circuit to output the converting drive current 218. That is, a change in value of the variable resistor 44 would cause a change in value of the converting drive current 218.

The high-frequency wave oscillator circuit 100 configured as described above operates as follows. An increase in the control voltage would cause an increase in the oscillator drive current 200 supplied by the variable current supply 20. The differential output ring oscillator made up of the first inverter 22 to the fourth inverter 28 outputs the first and second generated oscillatory signals 202, 204 at a higher oscillation frequency with a larger oscillator drive current 200. The differential amplifier 12 amplifies the first and second generated oscillatory signals 202, 204 to the first and second amplified oscillatory signals 206, 208, respectively, which have a sufficiently large amplitude. The transistors Tr20, Tr21 convert the first and second amplified oscillatory signals 206, 208 into the first and second current oscillatory signals 210, 212, respectively. The variable current supply 32 supplies the externally defined converting drive current 218 to the transistors Tr20, Tr21. The transistors Tr22 to Tr27 convert the value of the first and the second current oscillatory signals 210, 212, respectively, which are turned to the output current oscillatory signal 214 by a switching operation of the transistors Tr20, Tr21.

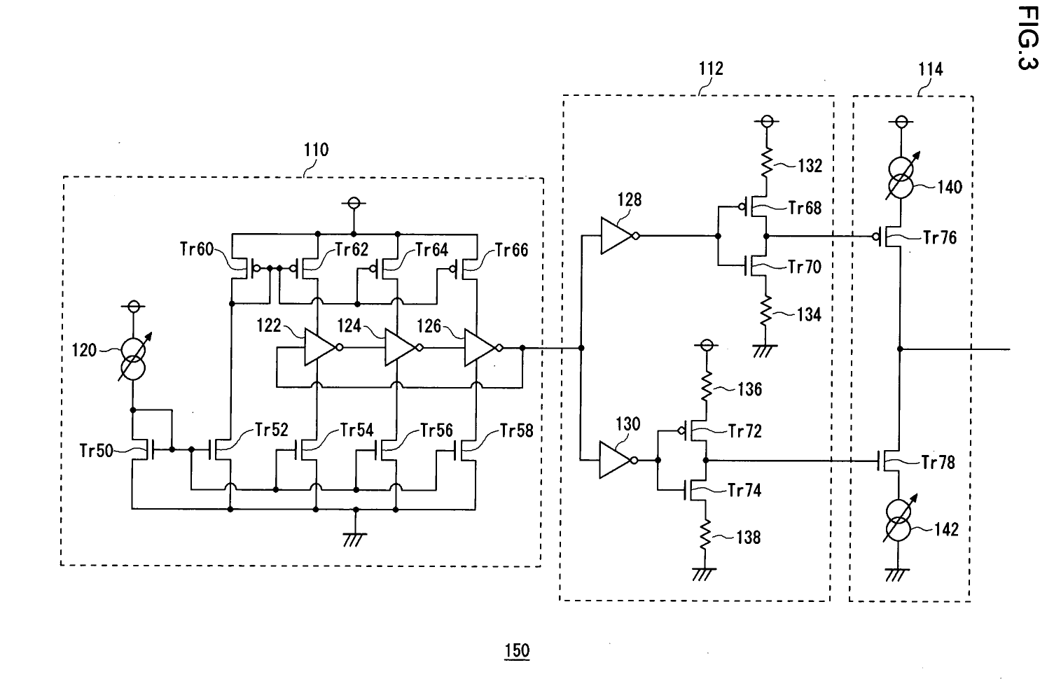

FIG. 3 illustrates the configuration of the high-frequency wave oscillator circuit 150 for comparison with the characteristics of the high-frequency wave oscillator circuit 100 of FIG. 1. The high-frequency wave oscillator circuit 150 includes an oscillatory signal generator circuit 110, a buffer 112, and a converter circuit 114. The high-frequency wave oscillator circuit 100 includes a variable current supply 120, a first inverter 122, a second inverter 124, a third inverter 126, and transistors Tr50 to Tr66. The buffer 112 includes a fourth inverter 128, a fifth inverter 130, a first resistor 132, a second resistor 134, a third resistor 136, a fourth resistor 138, and transistors Tr68 to Tr74. The converter circuit 114 includes a variable current supply 140, a variable current supply 142, a transistor Tr76, and a transistor Tr78.

The oscillatory signal generator circuit 110, which corresponds to the oscillatory signal generator circuit 10 of the high-frequency wave oscillator circuit 100, provides a current which varies in response to the control voltage applied. Transistors Tr50 to Tr58 constitute a current mirror circuit, while the transistors Tr60 to Tr66 also constitute a current mirror circuit. These current mirror circuits supply a current proportional to the output current from the variable current supply 120 to the ring oscillators each being made up of the first inverter 122, the second inverter 124, and the third inverter 126, to output an oscillatory signal at an oscillation frequency corresponding to the magnitude of the current supplied. Unlike the first and second generated oscillatory signals 202, 204 of the oscillatory signal generator circuit 10, the oscillatory signal is not a differential signal.

The buffer 112, which corresponds to the differential amplifier 12 of the high-frequency wave oscillator circuit 100, allows the fourth inverter 128, the first resistor 132, the transistor Tr68, the transistor Tr70, and the second resistor 134 to amplify the oscillatory signal delivered from the oscillatory signal generator circuit 110 to such an extent as to enhance the capability of driving at least the transistor Tr76, discussed later. On the other hand, the fifth inverter 130, the third resistor 136, the transistor Tr72, the transistor Tr74, and the fourth resistor 138 also operate in the same manner.

The converter circuit 114, which corresponds to the converter circuit 14 of the high-frequency wave oscillator circuit 100, converts the oscillatory signal amplified in the buffer 112 from a voltage to a current signal. The transistor Tr76 is a p-channel transistor and the transistor Tr78 is an n-channel transistor. Thus, the transistors are alternately turned ON with the oscillatory signal supplied to the gates, such that an oscillatory signal having a sink current and a source current switched is eventually delivered.

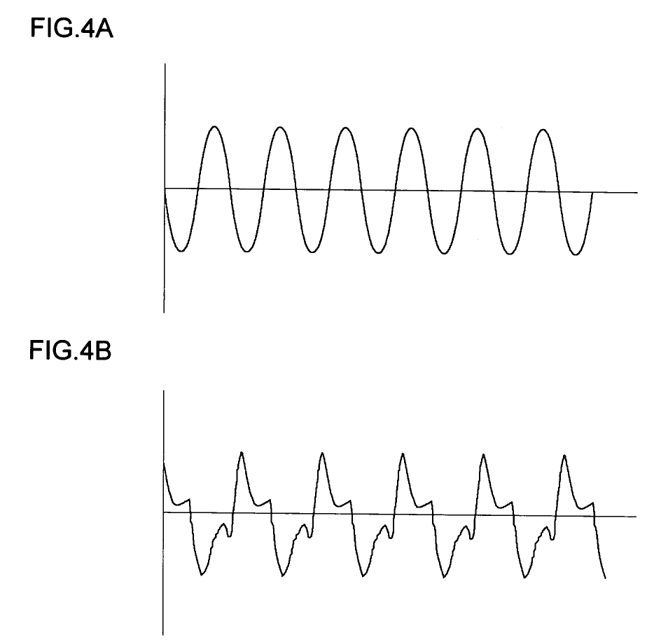

FIGS. 4(a) and 4(b) show the output waveforms experimentally obtained from the high-frequency wave oscillator circuit 100 of FIG. 1 and the high-frequency wave oscillator circuit 150 of FIG. 3, respectively. FIG. 4(a) shows the output current oscillatory signal 214 from the high-frequency wave oscillator circuit 100 of FIG. 1, having an oscillation frequency of 344.98 MHz and an amplitude of 42.2 mA with reduced distortion components. On the other hand, FIG. 4(b) shows an output from the high-frequency wave oscillator circuit 150 of FIG. 3, having values equivalent to those of FIG. 4(a), i.e., an oscillation frequency of 283.02 MHz and an amplitude of 40.0 mA but with more distortion components as compared with FIG. 4(a). The distortions in the waveform has resulted from the effects caused by an error in switching timing between the transistor Tr76 and the transistor Tr78 as well as from an oscillatory signal from the ring oscillator in the high-frequency wave oscillator circuit 150 taking an approximately rectangular waveform thereby causing many harmonic components to be contained in the oscillatory signal. By comparing FIG. 4(a) to FIG. 4(b) with almost the same oscillation frequency, it can be seen that more distortion components tend to be included in the signal waveform of FIG. 4(b) with more signal harmonic components. For this reason, the EMI characteristics of the high-frequency wave oscillator circuit 150 are reduced than those of the high-frequency wave oscillator circuit 100. On the other hand, since signal distortion components are cancelled out between the differential signals transmitted in the high-frequency wave oscillator circuit 100 of FIG. 1, the distortion components included in the signal are also reduced.

According to this embodiment, the oscillatory signal is produced and amplified in accordance with differential signals, thereby making it possible to reduce distortion components included in the current signal to be delivered. Furthermore, with reduced signal distortions, an apparatus with the high-frequency wave oscillator circuit can be operated with stability. Furthermore, the drive current to be provided is adjusted in magnitude at the stage of being eventually converted from a voltage signal to a current signal to adjust the amplitude of the drive current to be delivered, thereby making it possible to improve the operation efficiency of the circuit and reduce power consumption.

### FOURTH EMBODIMENT

The fourth embodiment relates to a high-frequency wave oscillator circuit that has the same configuration as that of the third embodiment. The third embodiment is designed such that the magnitude of the drive current flowing through the converting FET is variably adjusted using an external setting signal. However, in the fourth embodiment, an external setting signal is used to variably adjust the magnitude of the drive current flowing through the amplifying FET. The high-frequency wave oscillator circuit according to this embodiment adjusts the magnitude of the drive current flowing through the amplifying FET included in a differential amplifier. This causes the amplitude of the voltage signal for switching the converting FET to be varied, thereby changing the amplitude of the current signal to be finally delivered. A reduced drive current would reduce the amplitude of the differential signal to be delivered from the differential amplifier. Thus, this allows for reducing the noise which occurs between the power supply for the differential amplifier and the ground and which is added to the differential signal.

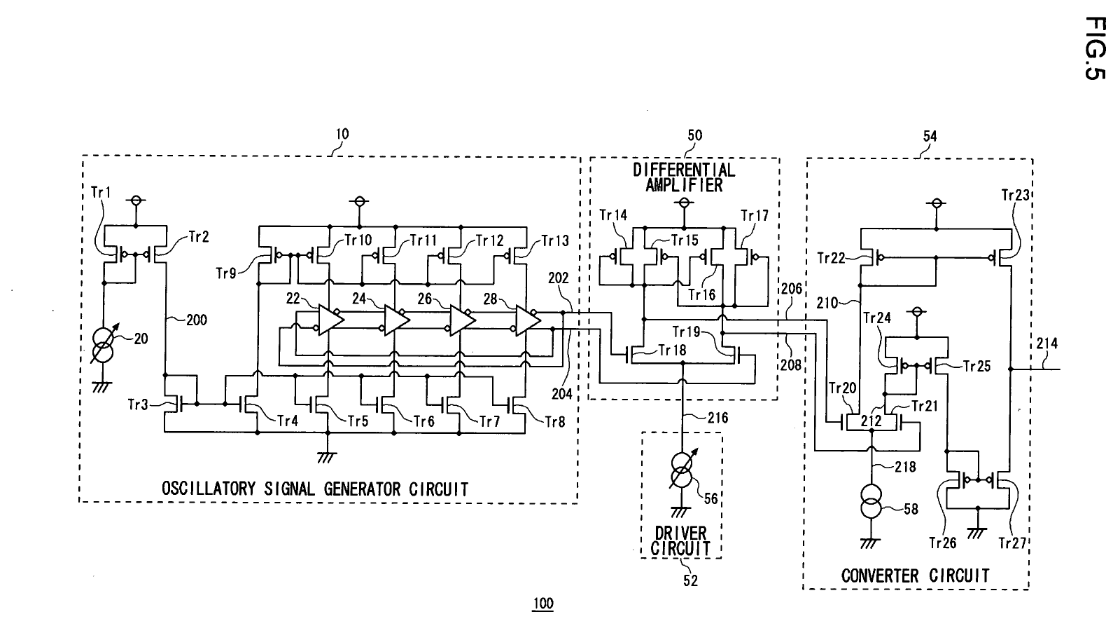

FIG. 5 illustrates the configuration of a high-frequency wave oscillator circuit 100 according to the fourth embodiment. A differential amplifier 50, a driver circuit 52, and a converter circuit 54 which are included in the high-frequency wave oscillator circuit 100 of FIG. 5 are different from the differential amplifier 12, the converter circuit 14, the driver circuit 16 which are included in the high-frequency wave oscillator circuit 100 of FIG. 1. The differential amplifier 50 is the differential amplifier 12 without the constant current supply 30, while the converter circuit 54 is the converter circuit 14 with an additional constant current supply 58. The driver circuit 52, which is an additional component, includes a variable current supply 56.

Like the constant current supply 30 of FIG. 1, the variable current supply 56 supplies the amplifier drive current 216 to the differential amplifier 50. The variable current supply 56, which has the same configuration as that of the variable current supply 32 of FIG. 2, adjusts the value of the internal variable resistor 44 (not shown) by the external setting signal 220 (not shown), thereby allowing for adjusting the magnitude of the amplifier drive current 216.

The converter circuit 54 converts the first and second amplified oscillatory signals 206, 208 into the output current oscillatory signal 214 having a sink and a source current switched. The magnitude of the converting drive current 218 flowing through the transistors Tr20, Tr21 used for conversion from a voltage signal into a current signal is based on the constant current supply 58 and thereby fixed.

In FIG. 5, to adjust the amplitude of the output current oscillatory signal 214, the magnitude of the converting drive current 218 to flow through the transistors Tr20, Tr21 is not directly adjusted, but the magnitude of the amplifier drive current 216 to flow through the differential amplifier 50 is adjusted based on an external setting signal, thereby adjusting the amplitude of the output current oscillatory signal 214. With the aforementioned configuration, the magnitude of the amplifier drive current 216 can be adjusted as small as required. This allows for reducing the noise which occurs between the differential amplifier 50, the power supply for the driver circuit 52, and the ground and which is added to the first and second amplified oscillatory signals 206, 208, thereby making it possible to output the output current oscillatory signal 214 with reduced noise effects.

The high-frequency wave oscillator circuit 100 configured as described above operates as follows. An increase in the control voltage would cause an increase in the oscillator drive current 200 supplied by the variable current supply 20. The differential output ring oscillator made up of the first inverter 22 to the fourth inverter 28 outputs the first and second generated oscillatory signals 202, 204 at a higher oscillation frequency with a larger oscillator drive current 200. The differential amplifier 50 amplifies the first and second generated oscillatory signals 202, 204 to the first and second amplified oscillatory signals 206, 208 having a sufficiently large amplitude, respectively.

The variable current supply 56 supplies the amplifier drive current 216 to the transistors Tr18, Tr19 in accordance with an external setting to satisfy the operation speed required of the differential amplifier 50. The transistors Tr20, Tr21 convert the first and second amplified oscillatory signals 206, 208 into the first and second current oscillatory signals 210, 212, respectively. The constant current supply 58 supplies the converting drive current 218 to the transistors Tr20, Tr21. The transistors Tr22 to Tr27 convert the values of the first and second current oscillatory signals 210, 212, respectively, which are turned to the output current oscillatory signal 214 by a switching operation of the transistors Tr20, Tr21.

According to this embodiment, the oscillatory signal is produced and amplified in accordance with differential signals, thereby allowing for reducing signal distortion components. Furthermore, a decrease in the drive current flowing into the differential amplifier would make it possible to output a current signal with reduced noise effects.

### FIFTH EMBODIMENT

In the fifth embodiment, the configuration of an apparatus or an LSI incorporating the high-frequency wave oscillator circuit of the third or the fourth embodiment will be explained.

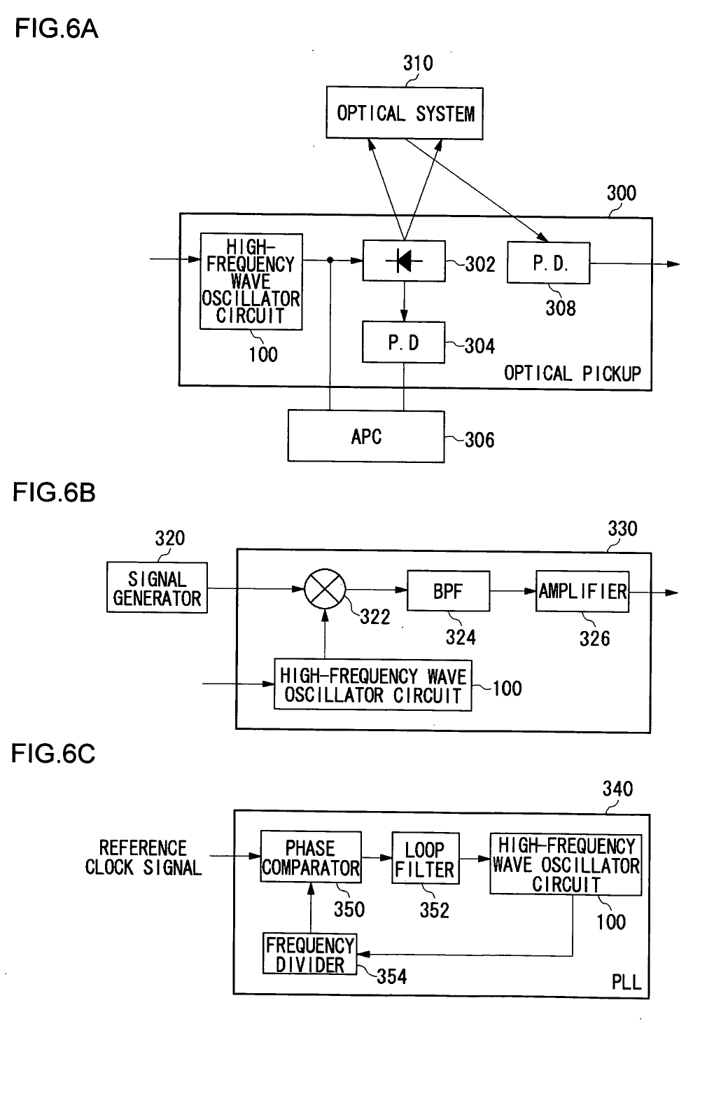

FIG. 6(a) shows the configuration of an optical pickup 300 or an exemplary application of the high-frequency wave oscillator circuit 100 according to the fifth embodiment. The optical pickup 300 includes the high-frequency wave oscillator circuit 100, a semiconductor laser chip 302, a monitor photodiode 304, and a light-receiving photodiode 308. The optical pickup 300 reads or writes signals on a disc or a storage medium in an information read/write apparatus such as an optical disc apparatus or an magneto-optical disc apparatus.

The semiconductor laser chip 302 emits a laser beam in accordance with a current supplied from the high-frequency wave oscillator circuit 100, discussed later. The high-frequency wave oscillator circuit 100 supplies a current signal to the semiconductor laser chip 302 in accordance with a control signal represented by the voltage from an APC (Automatic Power Control) circuit 306, discussed later.

An optical system 310 illuminates the storage medium disc (not shown) with a laser beam in the shape of an optical spot, emitted from the semiconductor laser chip 302, and directs a reflected beam from the disc to the light-receiving photodiode 308, discussed later.

The light-receiving photodiode 308 converts the reflected beam into a current signal. The current signal is further converted into a voltage signal. The monitor photodiode 304 converts a portion of the laser beam emitted from the semiconductor laser chip 302 into a current signal. The portion of the laser beam refers to a laser beam emitted from a face of the semiconductor laser chip 302, the face not opposing the optical system 310.

In accordance with a current signal delivered by the monitor photodiode 304, the APC circuit 306 delivers a control signal to the high-frequency wave oscillator circuit 100 or provides feedback control to the semiconductor laser chip 302 such that the semiconductor laser chip 302 always outputs a laser beam at a constant power. The APC circuit 306 is provided for the following reasons. The voltage signal delivered by the optical pickup 300 needs to be kept at a predetermined level. However, since different semiconductor laser chips 302 deliver laser beams at different power levels and are susceptible to variations in temperature, providing the same control to the different semiconductor laser chips 302 would not allow the laser beams to be delivered at the same power level. Thus, it is impossible to keep the voltage signal at a constant output level.

On the other hand, as described in the third and fourth embodiments, the amplitude of the output current oscillatory signal 214 can be increased, thereby allowing the semiconductor laser chip 302 to emit a laser beam with stability. Each component in this embodiment corresponds to each of the following components according to the first and second embodiments. That is, the optical pickup 300 corresponds to the optical pickup circuit 62, while the semiconductor laser chip 302 corresponds to the laser emission element LD, the first laser emission element LD1, and the second laser emission element LD2. The monitor photodiode 304 corresponds to the optical sensor element PD, the first optical sensor element PD1, and the second optical sensor element PD2. Likewise, the APC circuit 306 corresponds to the APC circuit 65, the first APC circuit 75, and the second APC circuit 76, while the high-frequency wave oscillator circuit 100 corresponds to the high-frequency wave superposition circuit 64.

FIG. 6(b) shows the configuration of a frequency converter circuit 330 or an exemplary application of the high-frequency wave oscillator circuit 100 according to the fifth embodiment. The frequency converter circuit 330 includes the high-frequency wave oscillator circuit 100, a multiplier circuit 322, a BPF (Band pass Filter) 324, and an amplifier 326. In a communications apparatus, the frequency converter circuit 330 converts a signal to be transmitted into a signal for transmission. More specifically, in a wireless apparatus, a base-band signal to be transmitted or an intermediate frequency signal obtained through the frequency conversion of the base-band signal is frequency converted into a radio frequency signal.

A signal generator 320 produces as a base-band signal a signal to be transmitted to frequency convert the base-band signal into one having an intermediate frequency.

The high-frequency wave oscillator circuit 100 receives a voltage corresponding to the radio frequency to be used for transmission to output a radio frequency signal.

The multiplier circuit 322 performs a frequency conversion on the intermediate frequency signal using the radio frequency signal. Furthermore, the BPF 324 reduces the effects of harmonics caused by the frequency conversion.

The amplifier 326 amplifies the output signal from the BPF 324 to a predetermined power level to transmit the signal over a radio propagation path.

As described with reference to the third or the fourth embodiment, the high-frequency wave oscillator circuit 100 is capable of delivering a large current signal even at a high oscillation frequency in accordance with a setting. This allows the frequency converter circuit 330 to output a radio frequency signal with stability.

FIG. 6(c) shows the configuration of a PLL 340 or an exemplary application of the high-frequency wave oscillator circuit 100 according to the fifth embodiment. The PLL 340 includes the high-frequency wave oscillator circuit 100, a phase comparator 350, a loop filter 352, and a frequency divider 354.

The phase comparator 350 compares phases and frequencies between an externally supplied reference clock signal and a reference clock signal supplied from the frequency divider 354, to output a direct-current signal proportional to the difference therebetween. The loop filter 352 removes harmonic components of a signal supplied to output a control voltage. The high-frequency wave oscillator circuit 100 outputs a clock signal at a frequency corresponding to the control voltage supplied. Here, a clock signal is delivered which has a frequency N times that of the reference clock signal. The output clock signal is divided by N in the frequency divider 354, and then supplied to the phase comparator 350 as a reference clock signal.

According to this embodiment, the high-frequency wave oscillator circuit which allows for adjusting the output current signal in amplitude and reducing signal distortion components is made available for various apparatus or LSIs.

In the third and the fourth embodiment, the differential amplifiers 12 and 50 are each made up of a single differential amplifier; however, the present invention is not limited thereto. For example, they may be each made up of a plurality of differential amplifiers. This modified example allows for further increasing the amplitude of the first and the second amplified oscillatory signal 206, 208. That is, the number of differential amplifiers may be determined based on the values required of the first and second amplified oscillatory signals 206, 208 that are delivered from the differential amplifier 12 or 50.

In the third embodiment, in accordance with the external setting signal 220, the driver circuit 16 outputs the converting drive current 218 variably in magnitude, which is to be supplied to the converter circuit 14. In the fourth embodiment, in accordance with the external setting signal 220, the driver circuit 52 outputs the amplifier drive current 216 variably in magnitude, which is to be supplied to the differential amplifier 50. However, the present invention is not limited to these embodiments, but may employ a combination thereof. In this case, in accordance with the external setting signal 220, the driver circuit 16 outputs the converting drive current 218 variably in magnitude, which is to be supplied to the converter circuit 14. At the same time, in accordance with the external setting signal 220, the driver circuit 52 outputs the amplifier drive current 216 variably in magnitude, which is to be supplied to the differential amplifier 50. This modified example allows more detailed settings. That is, the settings may be made to meet the magnitude of the amplitude, the distortion components, and power consumption of the output current oscillatory signal 214 which are required of the high-frequency wave oscillator circuit 100.

### EFFECTS OF THE THIRD TO FIFTH EMBODIMENTS

According to the third to the fifth embodiments, the amplitude of an oscillatory signal can be variably delivered with improved waveform distortion characteristics.

By now, the present invention has been described in accordance with the embodiments. The embodiment has been given solely by way of illustration. It will be understood by those skilled in the art that various modifications may be made to combinations of the foregoing components and processes, and all such modifications are also intended to fall within the scope of the present invention. Now, modified examples are shown below.

In the first and second embodiments of the present invention, the optical sensor element PD, the first optical sensor element PD1, and the second optical sensor element PD2 are incorporated into the optical pickup circuit 62. In a modified example, each of these optical sensor elements may be provided not in the optical pickup circuit 62 but on the main circuit board 61. Furthermore, in the first and second embodiments of the present invention, the APC circuit 65, the first APC circuit 75, and the second APC circuit 76 are provided on the main circuit board 61. In a modified example, each of these APC circuits may be incorporated into the optical pickup circuit 62.

The third to the fifth embodiments are set forth in the form of claims. (1) An oscillator circuit comprising:
an oscillatory signal generator circuit which delivers an oscillatory signal as a differential signal;
a differential amplifier which amplifies the differential signal delivered from the oscillatory signal generator circuit;
a converter circuit which converts the differential signal amplified by the differential amplifier from a voltage signal into a current signal; and
a driver circuit for variably delivering a drive current at a magnitude corresponding to an externally supplied setting signal to activate the converter circuit.

(2) An oscillator circuit according to (1), wherein the setting signal supplied to the driver circuit allows the converter circuit to increase the converted current signal in amplitude when the drive current is increased.

(3) An oscillator circuit comprising:
an oscillatory signal generator circuit which delivers an oscillatory signal as a differential signal;
a differential amplifier which amplifies the differential signal delivered from the oscillatory signal generator circuit;
a converter circuit which converts the differential signal amplified by the differential amplifier from a voltage signal into a current signal; and
a driver circuit which variably delivers a drive current at a magnitude corresponding to an externally supplied setting signal to activate the differential amplifier.

(4) An oscillator circuit according to (3), wherein the setting signal supplied to the driver circuit allows the differential amplifier to increase an operating speed when the drive current is increased.

According to the present invention, in an apparatus incorporating an optical pickup circuit, it is possible to reduce EMI noise and the size of the circuit.

1. A laser driver circuit incorporating into the same package a drive element which drives a laser emission element and a high-frequency wave superposition circuit which superposes a high-frequency current on a drive current produced by the drive element.

2. A laser driver circuit comprising:
an input terminal which receives a control signal from an external automatic power control circuit which controls laser output from a laser emission element at a constant level based on a detected result thereof obtained by an optical sensor element;
a drive element which drives the external laser emission element based on the control signal;
an output terminal which delivers a drive current produced by the drive element to the laser emission element; and
a high-frequency wave superposition circuit which superposes a high-frequency current on the drive current delivered to the laser emission element.

3. A laser driver circuit comprising:
a plurality of input terminals which receive respective control signals for a plurality of laser emission elements of different frequencies from an external automatic power control circuit which controls the laser output from the laser emission elements at a constant power level based on a detected result thereof obtained by an optical sensor element;
a plurality of drive elements which drive the plurality of laser emission elements based on the control signals, respectively;
a plurality of output terminals which deliver respective drive currents produced by the plurality of drive elements to the plurality of laser emission elements, respectively; and
a high-frequency wave superposition circuit for superposing a high-frequency current on each of the drive currents to be delivered to the plurality of laser emission elements.

4. An optical pickup circuit comprising:
the laser driver circuit according to claim 1; and
a laser emission element which is connected external to the laser driver circuit and driven with the drive current superposed with the high-frequency current.

5. An optical pickup circuit comprising:
the laser driver circuit according to claim 2; and
a laser emission element which is connected external to the laser driver circuit and driven with the drive current superposed with the high-frequency current.

6. An optical pickup circuit comprising:
the laser driver circuit according to claim 3; and
a laser emission element which is connected external to the laser driver circuit and driven with the drive current superposed with the high-frequency current.

7. An optical disc apparatus comprising the optical pickup circuit according to claim 4.

8. An optical disc apparatus comprising the optical pickup circuit according to claim 5.

9. An optical disc apparatus comprising the optical pickup circuit according to claim 6.
